(19) United States
(12) Patent Application Publication
(10) Pub. No.: US 2003/0100851 A1
(43) Pub. Date: May 29, 2003

(54) Massage tube

(76) Inventor: James Clement Martinec, Huntington Beach, CA (US)

Correspondence Address: JAMES C. MARTINEC, 15922 PILGRIM CR., HUNTINGTON BEACH, CA, 92647, US

(21) Appl. No.: 09/994,282

(22) Filed: Nov. 23, 2001

(51) Int. Cl. A61H 15/00

(52) U.S. Cl. 601/121; 601/136

(57) ABSTRACT

An apparatus used for massaging a person's back by themselves. By laying you r back over the cylinder shaped apparatus (Massage Tube) in a horizontal position parallel to the ground and knees bent you slide your body back and forth over the Massage Tube with the use of your legs. The ribbed and semi-pointed surfaces coupled with the weight of your body and sliding motion massages the muscles and associated areas in the back and neck, however not limited to the back and neck. A key element of this apparatus is the ability to adjust the height and pressure by an inlet air valve located on the side. This allows the apparatus to adapt to the users body shape and comfort level by adding or releasing air. The unique cylinder design is the key element of the invention helping stabilize and balance the user during massaging, exercising and stretching.

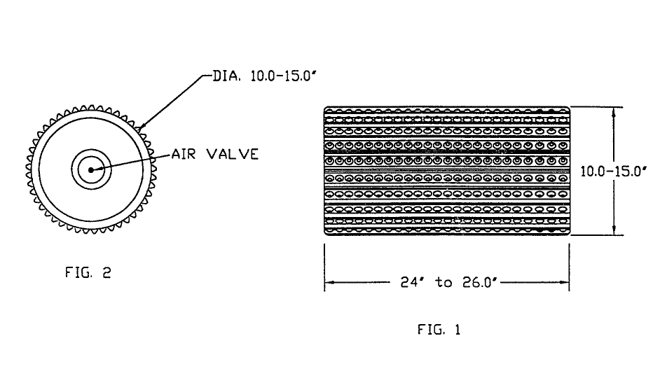

### BACKGROUND OF THE INVENTION

This invention is relative to the healthcare, relaxation and exercise fields and more directly to an apparatus designed for massaging certain areas of the body.

There are great benefits to massaging the body, relaxation, stress relief, better circulation, increased flexibility and overall health. This apparatus pertains to the massaging of the body and more particularly to be able to massage many areas of your body yourself at home, but not limited to home use or the use of additional persons.

Using the apparatus massages can be accomplished easily and inexpensively in the comfort of your own home. The intent of this invention is not to replace other methods of massage but to offer alternatives to how massage can be facilitated and more frequently obtained.

### SUMMARY OF INVENTION

The primary objective of this invention is to provide an apparatus for administering a body massage to your self by yourself.

The secondary objective of this invention is to provide an apparatus, which will allow for easy and frequent body massages. Frequent being relative to the user, the typical usage objective would be daily, but not limited to extended use.

An additional objective of this said invention is to provide an relatively inexpensive apparatus for administering a body massage to your self by yourself.

An additional objective of this said invention is to provide an apparatus with the capability to massage your neck and back.

An additional objective of this said invention is to provide an apparatus with the capability to massage your stomach and chest.

An additional objective of this said invention is to provide an apparatus with the capability to massage your legs.

Another use of this said invention is the ability to stretch over it and use it as a moderate stretching device.

Another use of this said invention is the product of exercise extended from the use of the apparatus during stretching and massaging.

To summarize the above mentioned claims and objectives of this said invention, an apparatus said “Massage Tube” can be used for self-administered body massage, stretching and exercise. The intent of this invention is to supply an apparatus, which helps establish and maintain overall health and stress relief to an individual through massage, stretching and exercise.

1. An apparatus constructed from a rubber material in a cylinder design, which with a common air inlet may be inflated or deflated easily with most conventional air pumps, including manual air pumps. The circumference of the said rubber cylinder will consist of ribbed and pointed formed surfaces. The rubber cylinder (Massage Tube) will be physically wider than a human body allowing a comfortable fit and balance during use.

2. An apparatus as claimed in claim 1, wherein by placing the apparatus (Massage Tube) on the ground and laying your back horizontally to the ground on top of the said Massage Tube and by extending and bending your legs at the knees you slide back and forth over the Massage Tube. The force of your weight on the ribbed and pointed surfaces and the sliding motion massage your back and neck.

3. An apparatus as claimed in claim 1 wherein by placing the apparatus (Massage Tube) on the ground and laying your stomach horizontally to the ground on top of the said Massage Tube and by extending and bending your legs at the knees and the use of you r arms you slide back and forth over the Massage Tube. The force of your weight on the ribbed and pointed surfaces and the sliding motion massage your upper legs,

4. An apparatus as claimed in claim 1, wherein by placing the apparatus (Massage Tube) on the ground and laying the side of your body horizontally to the ground on top of the said Massage Tube and by extending and bending your legs at the knees and the use of you r arms you slide back and forth over the Massage Tube. The force of your weight on the ribbed and pointed surfaces and the sliding motion massage your hips and sides or the body.
